(19) United States
(12) Patent Application Publication
(10) Pub. No.: US 2005/0047269 A1
(43) Pub. Date: Mar. 3, 2005

(54) Stirrer

(76) Inventor: Chun Yong Chen, Taipei (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/648,296

(22) Filed: Aug. 27, 2003

(51) Int. Cl. B01F 1/00; B01F 7/00; B01F 13/00

(52) U.S. Cl. 366/129; 366/343; 366/325.8

(57) ABSTRACT

A stirrer comprises a stirring shank and a flow-disturbing member; the flow-disturbing member is provided on the stirring shank and composed of two elongated strip members respectively provided on the upper and lower edges thereof as well as spacedly provided with a plurality of flow-disturbing blades. Each flow-disturbing blade is allocated between the two elongate strip members in a predetermined inclined angle, so that when the stirring shank is rotated, higher stirring speed and more uniform stirring effect can be obtained. The present invention suits stirring devices for paints (such as oil paint) used on a building.

### BACKGROUND OF THE INVENTION

1. Field of the invention

The present invention is related to a stirrer, and especially to a stirrer with fast stirring speed and uniform stirring effect; it suits stirring devices for paints (such as oil paint) used on a building.

2. Description of the Prior Art

After construction or maintenance of a building, people mostly use paints such as oil paint to beautify the outlook of the building. Oil paints normally are divided into two classes: one is a kind of watery paint in which water is the main solvent, the other is a kind of oily paint including non water-mixable solvent; products of the watery paint can be clearly removed just by using soap and water, while the oily paint needs certain kind of diluent such as solvent rosin, banana scent solvent or toluene to be removed.

Paints are mixtures of pigments and resin liquids, specific weights of the ingredients of them are different, it is inevitable that segregation and sediment of pigments may occur during the procedure of production, storage till use, hence they must be adequately stirred and mixed up till being completely uniform before use, and shall be kept on stirring during work period.

Before painting, a worker normally uses a stirrer to stir paint. In order to increase the speed and uniformity of painting, as shown in FIG. 1, a conventional stirrer 1 is composed of a shank 10 and a stirring member 11; the stirring member 11 is combined with one end of the shank 10, and is in an undulated form, it is provided thereon spacedly with a plurality of tapered stirring blades 112, an elongated slot 111 is formed between every two stirring blades 112, hence when the shank 10 is rotated, the stirring blades 112 can rotate together with the shank 10, and the paint can flow among the elongated slots 111 (not shown).

However, in conventional designing of a stirrer, only a goal of liquid stirring is required, when it is desired to increase the uniformity of paint, much time needs to be taken for stirring, this is not ideal.

In view of the above stated, in order to eliminate the flaws and to increase the speed and uniformity of painting stirring, the present invention is provided.

### SUMMARY OF THE INVENTION

The primary object of the present invention is to provide a stirrer with fast stirring speed and uniform stirring effect.

In order to achieve the above stated object, the stirrer provided in the present invention comprises a stirring shank and a flow-disturbing member; the flow-disturbing member is provided on the ending section of the stirring shank.

The flow-disturbing member provided on the stirring shank is composed of two elongated strip members respectively provided on the upper and lower edges thereof as well as spacedly provided with a plurality of flow-disturbing blades; each flow-disturbing blade is allocated between the two elongated strip members in a predetermined inclined angle, so that when the stirring shank is rotated, liquid can flow between every two neighboring flow-disturbing blades.

The stirring shank gradually spreads outwards from the middle section thereof to form a wide surface, the shank has an abutment annulus near the upper end thereof for abutting and connecting thereon of an external rotating equipment, the shank has on the lower end thereof a protruding positioning block.

Thereby, when the stirring shank is rotated, liquid can flow between every two neighboring flow-disturbing blades.

The present invention will be apparent after reading the detailed description of the preferred embodiment thereof in reference to the accompanying drawings.

### BRIEF DESCRIPTION OF THE DRAWINGS

FIG. 1 is a perspective view showing the appearance of a conventional stirrer;

FIG. 2 is a perspective view showing the appearance of an embodiment of the present invention;

FIG. 3 is a schematic front view of a flow-disturbing member of the embodiment of the present invention;

FIG. 4 is a top view of the embodiment of the present invention;

FIG. 5 is a schematic perspective view showing use of the embodiment of the present invention.

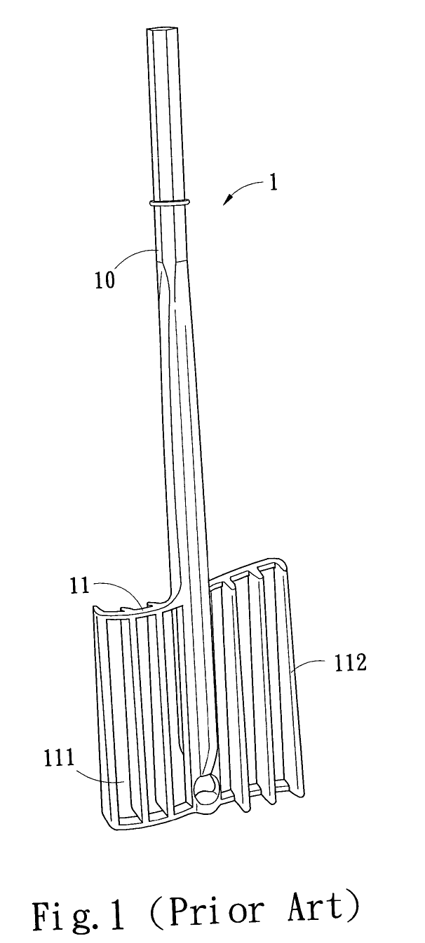

### DETAILED DESCRIPTION OF THE PREFERRED EMBODIMENT

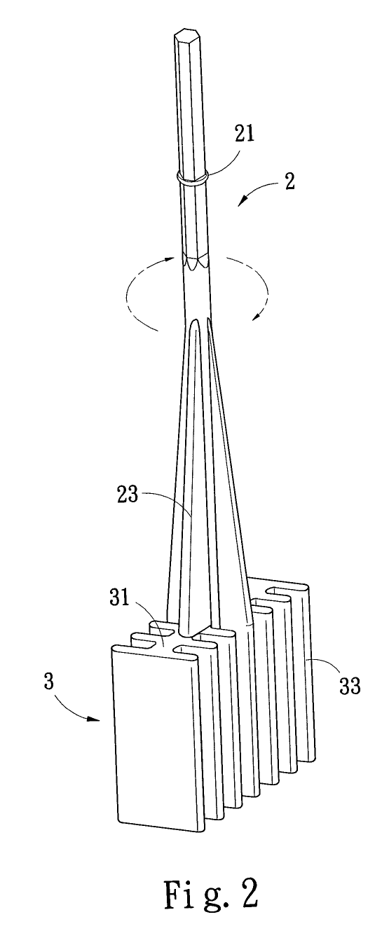

Referring firstly to FIGS. 2-5, an embodiment of the stirrer provided in the present invention as depicted comprises a stirring shank 2 and a flow-disturbing member 3; the flow-disturbing member 3 is provided on the ending section of the stirring shank 2.

The stirring shank 2 gradually spreads outwards from the middle section thereof to form a wide surface 23, the shank 2 has an abutment annulus 21 near the upper end thereof for abutting and connecting thereon of an external rotating equipment 4, and the shank 2 has on the lower end thereof a protruding positioning block 22 having thereon a hole 221 for hanging.

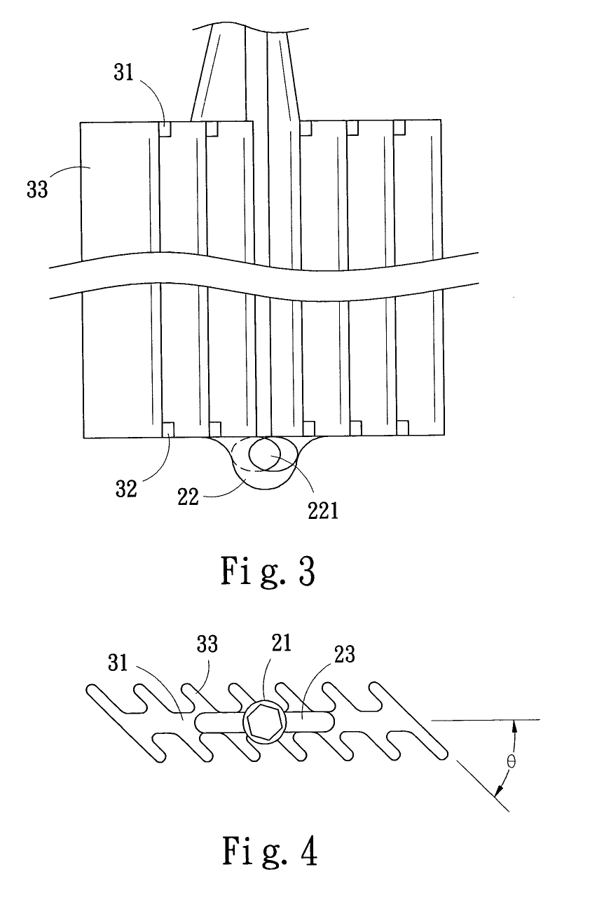

The flow-disturbing member 3 provided on the stirring shank 2 is composed of two elongated strip members 31, 32 respectively provided on the upper and lower edges thereof as well as spacedly provided with a plurality of flow-disturbing blades 33; each flow-disturbing blade 33 is allocated between the two elongate strip members 31, 32 in an inclined angle, the flow-disturbing blades 33 are mutually parallel to form a shape of a fence. Particularly, each flow-disturbing blade 33 is allocated between the two elongated strip members 31, 32 in an inclined angle of 40-50 degrees (as shown in FIGS. 3, 4),

Thereby, when the stirring shank 2 is rotated, liquid 5 can flow between every two neighboring flow-disturbing blades 33.

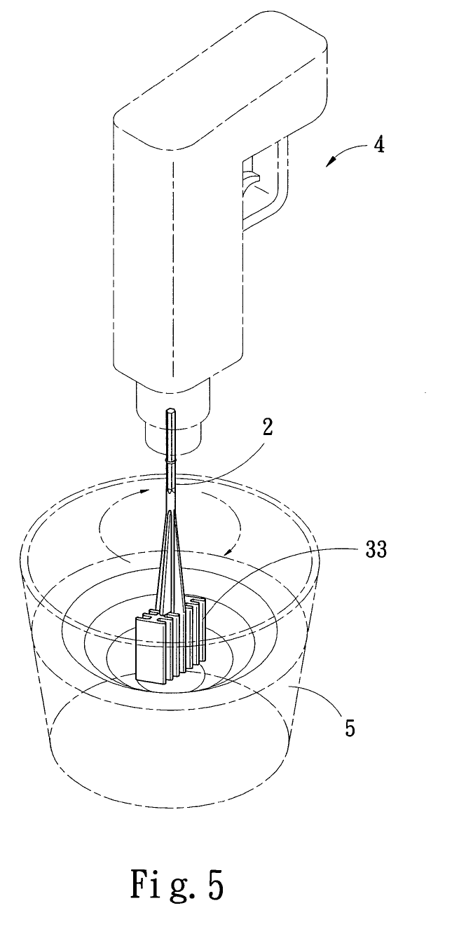

When in practicing, such as is shown in FIG. 5, when the upper end of the stirring shank 2 is connected with the external rotating equipment 4, it can be driven to rotate; by virtue that the mutually parallel flow-disturbing blades 33 allocated each between two elongated strip members 31, 32 in an inclined angle of 40-50 degrees, the liquid (such as oil paint) 5 can flow downwards to form a vortex, this can increase the speed and uniformity of stirring. After use, the stirring shank 2 can be hung up at some place (not shown) by using the hole 221 provided on the positioning block 22 on the lower end of the stirring shank 2.

The present invention thereby has the following advantages:
1. The present invention takes advantage of the arrangement of the flow-disturbing blades to generate a vortex during stirring, it can largely increase the speed of stirring, and thereby can increase uniformity of stirring.
2. The present invention is structurally simple, and can be convenient for hanging up or carrying by using the hole provided on the positioning block on the lower end of the stirring shank.

1. A stirrer comprising a stirring shank and a flow-disturbing member, wherein said flow-disturbing member being provided on an ending section of said stirring shank, said stirrer is characterized in that:
said flow-disturbing member provided on said stirring shank is composed of two elongated strip members respectively provided on an upper and a lower edge thereof as well as spacedly provided with a plurality of flow-disturbing blades; each of said flow-disturbing blades is allocated between said two elongated strip members in a predetermined inclined angle, so that when said stirring shank is rotated, liquid flows between every two neighboring ones of said flow-disturbing blades;
said stirring shank gradually spreads outwards from a middle section thereof to form a wide surface, said stirring shank has an abutment annulus near an upper end thereof for abutting and connecting thereon of an external rotating equipment, said stirring shank has on a lower end thereof a protruding positioning block.

2. The stirrer as in claim 1, wherein, said flow-disturbing blades are mutually parallel to form a shape of a fence, each of said flow-disturbing blades is allocated between said two elongated strip members in an inclined angle of 40-50 degrees.

3. The stirrer as in claim 1, wherein, said two elongated strip members are provided mutually parallelly on said stirring shank.

4. The stirrer as in claim 1, wherein, said protruding positioning block has thereon a hole for hanging.

5. The stirrer as in claim 1, wherein, said stirring shank and said flow-disturbing blades are integrally formed.
